(19) United States
(12) Patent Application Publication
(10) Pub. No.: US 2018/0335545 A1
(43) Pub. Date: Nov. 22, 2018

(54) METHODS OF DIAGNOSING DEFECTS IN A PROCESSING UNIT OR HYDRUALIC FRACTURING PROCESS BY ANALYZING SOLID PARTICLES FROM THE PROCESSING UNIT OR HYDRUALIC FRACTURING PROCESS

(71) Applicant: SandCheck, LLC, Houston, TX (US)

(72) Inventor: Margaret Maureen DALTHORP, Houston, TX (US)

(21) Appl. No.: 15/985,396

(22) Filed: May 21, 2018

Related U.S. Application Data
(60) Provisional application No. 62/509,364, filed on May 22, 2017.

(51) Int. Cl. G01V 11/00; E21B 49/02; E21B 49/08; E21B 43/267; G01N 15/10

(52) U.S. Cl. CPC G01V 11/002; E21B 49/02; E21B 47/0002; E21B 43/267; G01N 15/10; E21B 49/08

(57) ABSTRACT

The present disclosure relates to methods for diagnosing a defect in a processing unit. The present disclosure provides a method that includes obtaining test samples from processing units, determining at least one property of a particle from the processing unit, and diagnosing a defect in the processing unit. A method of diagnosing a defect in a hydraulic fracturing process is disclosed. The present disclosure provides a method that includes obtaining a test sample, determining at least one property of a proppant, and diagnosing a defect in the hydraulic fracturing process. One benefit of the method can be the cost-effective detection and diagnosis of a defect before, during, or after the defects interfere with production or processing.

### CROSS-REFERENCE TO RELATED APPLICATIONS

This application claims priority to U.S. Provisional Application No. 62/509,364, filed on May 22, 2017, the contents of which are incorporated by reference in their entirety.

### TECHNICAL FIELD

The present disclosure relates to a method of diagnosing, determining, and possibly preventing defects in a processing unit associated with hydrocarbon production or processing. In an embodiment, the present disclosure relates to determining properties of particles sampled from processing units and diagnosing a defect of the processing unit based on the solid particle properties. The present disclosure relates to a method of diagnosing, determining, and possibly preventing a defect in a hydraulic fracturing process. In an embodiment, the present disclosure relates to determining properties of proppant particles sampled prior to, during or after hydraulic fracturing and diagnosing a defect in the hydraulic fracturing process based on the proppant particle properties.

### BACKGROUND

The oil and gas industry is one of the most profitable, critical, and well-developed areas of technology known. However, despite intense research and huge financial incentives for improvements, the engineering problems posed by the nature of oil and gas production make the development of viable solutions inherently challenging. For example, hydrocarbons (oil and gas) are typically produced from wellbores or boreholes in the earth's formation by drilling to desired depths to recover the hydrocarbons from within the earth's formations. In practice, a wellbore is several inches to several feet wide and can extend down into the earth for miles. Typically, the shallow portion of the wellbore is lined with a metal casing to prevent the earth's formations from caving into the wellbore. Once the wellbore has been drilled, a metal pipe or casing is set in the wellbore by injecting cement between the casing and the wellbore to avoid formation collapse and leakage. Afterwards, the wellbores are typically completed and put into production. In addition, branching and lateral wellbores are often drilled from the main wellbore to improve the production of hydrocarbons.

The wellbores of oilfields are typically used for years. There are a wide variety of operations that can be performed to increase the life and quantity of hydrocarbons produced from the wellbores. One of these techniques is known as hydraulic fracturing, or simply fracking (“frac” for short), which is a procedure where fluids are pumped down into the wellbore at high pressures to form fractures within the formation surrounding the wellbore in the hopes of increasing production. To avoid having the fractures close as soon as the pressure of fracturing operations is reduced, small particles, known as proppants, can be pumped into the wellbore under high pressure in the hope of propping or wedging the fractures open.

There is a need for an efficient, cost-effective method that can detect and diagnose defects in the wellbores and processing unit associated with hydrocarbon production before, during, or after the defects interfere with the production or processing. There is a need for an efficient method that can detect or diagnose defects in wellbores and processing units without requiring production or processing to stop whiles samples are taken or analysis is performed. There is a need for a method that can detect or diagnose defects in hydraulic fracturing processes to improve or avoid defects in the hydraulic fracturing process.

### SUMMARY

One of the challenges associated with the production of hydrocarbons from wellbores is the ability to detect, monitor, or analyze what is happing in the wellbore. For example, due to the shape of the wellbore and the extreme pressures and temperatures used during operation, most analytical equipment cannot be used to monitor the conditions in the wellbore. In addition, the nature of the complex mixtures of solids and fluids flowing into and out of the wellbore render most chemical analytical techniques irrelevant. The same analytical problems often plague processing units associated with hydrocarbon production, because the processing units are often dealing with large volumes of mixtures of solids and liquids flowing through miles of flowlines or into large containers. Like the wellbores, the processing units are often expected to function for years under harsh environmental conditions.

It is desirable to be able to monitor or analyze the conditions of hydrocarbon production from a wellbore or in a processing unit to avoid or detect defects in the wellbore or processing unit. Some researchers have developed specialized cameras and other analytical equipment for insertion into wellbore and processing units. Some researchers have developed specialized particles, e.g. fluorescent or radioactive, that can be monitored through the earth's formations or through the materials of the processing unit during production or processing. Some researchers have developed methods of analyzing the liquids produced from the wellbore to try to gain insight into the conditions of the wellbore or processing unit. Each of these techniques can provide insight into the conditions of the wellbore or processing unit, but none provides a comprehensive solution, and few provide an efficient or cost-effective solution.

The present disclosure relates to a method of analyzing solid particles that are taken from wellbores, processing units, or a hydraulic fracturing process for a variety of reasons. Previous analytical methods have focused on monitoring the activity of liquid materials that enter the wellbore, processing unit, or hydraulic fracturing process. A few analytical methods have analyzed liquid samples from the wellbore or processing unit to detect defects in the wellbore or processing unit. However, it is believed that these efforts were focused exclusively on the liquid materials from the sample. The solids and solid particles from wellbores, processing units, and hydraulic fracturing process have been considered waste and have been thrown out or recycled. It is believed that no one until now has tried to analyze solid materials to determine if a defect is present in the wellbore, processing unit, or hydraulic fracturing process. Solid materials have been considered waste materials, with efforts focused on disposal of the solid materials.

It has been surprisingly discovered that it is possible to diagnose a defect in a wellbore or processing unit by determining at least one property of particles in a test sample relative to a control sample, multiple control samples, a percentage of test sample, or a data base. Similarly, it has been surprisingly discovered that it is possible to diagnose a defect in a hydraulic fracturing process by determining at least one property of a proppant relative to a control sample. One benefit of the method can be the cost-effective detection and diagnosis of a defect before, during, or after the defects interfere with production or processing. Another benefit of the method can be the detection or diagnosis of defects in wellbores, processing units, or a hydraulic fracturing process without requiring production or processing to stop while samples are taken or analysis is performed.

The present disclosure relates to a method of diagnosing a defect in a processing unit. In an embodiment, the method of diagnosing a defect in a processing unit includes obtaining a test sample from the processing unit, wherein the processing unit comprises at least one of a wellbore, a wellbore completion string, a well formation, a well fracture, a well filter system, a well screen, a production facility screen, a chemical pipeline, a petroleum production facility, a chemical transportation vehicle, a chemical processing facility, fracture stimulation equipment, fracture storage tanks, tubing, flowlines, storage tanks, hoses and an injection disposal facility; determining at least one property of particles in the test sample relative to a relative to a control sample, multiple control samples, or as a percent of the test sample, wherein the test sample comprises solids which entered the processing unit and wherein the property is at least one of a number, size, weight, geometry, sphericity, roundness, compressive strength, crushing strength, tensile strength, elastic modulus, yield stress, ductility, grain size, grain angularity, saturation, hardness, resistivity, porosity, grain density, bulk density, permeability, digital image comparison, pressure, crush resistance and temperature of the particles; and diagnosing the defect in the processing unit.

In an embodiment, the method includes diagnosing the defect in the processing unit as a mechanical issue or corrosion or undiagnosed source of metal fragments in the processing unit when about 2% or more of metal particles relative to a total distribution of the test sample are detected. In an embodiment, the method includes diagnosing the defect in the processing unit with cement degradation when about 2% or more of cement particles relative to a total distribution of the test sample are detected. In an embodiment, the method includes diagnosing the defect in the processing unit with at least one of filter failure, screen failure, wellbore collapse, formation collapse, and well fracture collapse when about 10% or more of formation particles or proppants relative to a total distribution of the test sample is determined. In an embodiment, the test sample comprises at least one of a completion solid sample material, a completion flow back material, or a drilling material during frac stage drill outs, production solid sample obtained any time throughout a life of the processing unit, or a production flow back sample during and after fracture stimulation. In an embodiment, the test sample comprises a mixture of solids, liquids and gas. In an embodiment, a liquid is removed from the test sample before determining the at least one property of the particles relative to the total distribution of the test sample is detected. In an embodiment, at least one property of the particles is determined by examining the test sample by magnified imaging and recording digital images. In an embodiment, the at least one property of the particles is determined by passing the particles through at least one sieve, by a laser diffraction technique, or by a particle size analyzer. In an embodiment, the size of the particles is determined by measuring a shortest radius of at least one particle. In an embodiment, the method also includes determining at least one of a type, a material, or an origin of an unidentified particle by analyzing the unidentified particle by at least one of mass spectroscopy, nuclear magnetic spectroscopy, IR spectroscopy, x-ray spectroscopy, gamma ray spectroscopy, XRF spectral gamma analysis, elemental analysis, XRD microscopy, and UV-Vis spectroscopy to provide analytical data. In an embodiment, the method also includes determining at least one of the type, the material, or the origin of the unidentified particle by data matching at least one property of the unidentified particle to a material profile in a publicly or privately available data resource and/or by digital image recognition. In an embodiment, the data resource comprises at least one of a physical sample and data from a physical sample. In an embodiment, the data resource comprises cased and open hole logs, mud logs, Logging While Drilling (LWD) logs, downhole imaging logs, directional survey logs, well fluid and pressure sampling, well completion information, core analysis and photos, cuttings, sidewall cores analysis, and data acquired under downhole well conditions. In an embodiment, the method also includes diagnosing the defect in the processing unit with at least one of well completion failure, filter failure, screen failure, wellbore collapse, formation collapse, and well fracture collapse when an increase of formation particles of from about 20% or more relative to the total distribution of the test sample is determined, and then identifying a formation weakness location in the wellbore by determining a correlation between sample formation particles to drill cuttings control samples from the wellbore. In an embodiment, the method also includes recording or documenting the data, wherein the data comprises at least one of a field note, a photograph of a sample location, well site information, processing unit information, wellbore information, completion history, production history, sample method, and the at least one property of the particles, and determining potential future defects and timing of potential defects such as refracturing needs or wellbore remediation by performing statistical or mathematical modeling based on the data. In an embodiment, the well site information comprises at least one of: a well name, a well location, a name of a well operator, a well identifying number, a date, a time of obtaining the test sample, and a source of the test sample. In an embodiment, the method also includes sending a request for at least one of a graphical particle size log and a particle size versus percentile estimation from the data resource to an administrative processor. In an embodiment, the method also includes sending a request for an input of the at least one properties of the particles from the data resource to an administrative processor.

A method of diagnosing a defect in a hydraulic fracturing process is disclosed. In an embodiment, the method includes obtaining a test sample from at least one of the hydraulic fracturing process before, during, or after the hydraulic fracturing process, during the completion and production process during a life of a processing unit; determining at least one property of proppant particles in the test sample relative to a control sample, wherein the control sample comprises a proppant sampled during fracture stimulation of a well bore or a standard sample of the proppant specified for a fracture stimulation of the wellbore, wherein the test sample comprises solids which entered the hydraulic fracturing process and wherein the property is at least one of a number, size, weight, geometry, sphericity, roundness, compressive strength, crushing strength, tensile strength, elastic modulus, yield stress, ductility, grain size, grain angularity, saturation, hardness, resistivity, porosity, grain density, bulk density, permeability, pressure, and temperature of the proppant particles; and diagnosing the defect in the hydraulic fracturing process.

In an embodiment, the method includes diagnosing the defect in the hydraulic fracturing process as a failure to place the proppant particles into a fracture when a number of proppant particle properties does not change or decreases from about 1% to about 10% relative to the control sample. In an embodiment, the method includes determining an increase of from about 20% or more of proppant particles exhibiting a change in a least one of sphericity, roundness, and size relative to the control sample, and diagnosing the defect in the hydraulic fracturing process, completion design, or production drawdown plan as displacement of placed proppant. In an embodiment, the method includes determining an increase of from about less than 5% of proppant particles and greater than 10% of formation, and provided that the formation was fracture stimulated, the absence of proppant in the test sample, and diagnosing the defect in the hydraulic fracturing process as a failure to place proppant into a fracture in a wellbore, a well formation, or a well fracture during or after the hydraulic fracturing process. In an embodiment, the method includes determining an increase of from about 10% to about 100% of crushed proppant particles relative to the control sample, and diagnosing the defect in the hydraulic fracturing process as at least one of unsuitable proppant, unsuitable proppant transport fluid, excessive pressure, and effective stress in a wellbore, a formation, or a fracture during or after the hydraulic fracturing process. In an embodiment, the method includes determining an erosion or a corrosion of the proppant over time by comparing a change of at least one property of sphericity, roundness, size, and compressive strength, or other recorded, estimated, or predicted property to the control sample and optionally two or more samples obtained during production, or before, during or after the hydraulic fracturing stimulation and diagnosing the proppant material change as an indicator of a pressure or rock mechanic change in the formation. In an embodiment, the method includes diagnosing the defect in the processing unit with at least one of changes in rock mechanics, formation pore pressure, or effective stress when greater than 20% of formation particles relative to a total distribution of the test sample are fine grained or crushed. In an embodiment, the method includes determining the erosion or compaction of the formation over time by comparing a change of relative percentages of particles in test samples, and diagnosing the producing unit and formation rock property variations. In an embodiment, the method includes diagnosing the defect in the processing unit as a formation producing issue when about 10% or more of Halite (NaCl) as a solid relative to a total distribution of the test sample is detected. In an embodiment, the at least one property of the particles is determined by examining the test sample by XRF analysis.

### BRIEF DESCRIPTION OF THE DRAWINGS

The foregoing summary, as well as the following detailed description of the embodiments, will be better understood when read in conjunction with the attached drawings. For the purpose of illustration, there are shown in the drawings some embodiments, which may be preferable. It should be understood that the embodiments depicted are not limited to the precise details shown.

FIG. 1 is a photograph at 20× magnification of a sample from a well, containing fine to medium dolomite grains that are very angular.

FIG. 2 is a photograph at 20× magnification of a sample from a well, containing crushed frac sand, which is very fine grained, has low sphericity, and is very angular.

FIG. 3 is a photograph at 20× magnification of a sample from a well, containing fine to medium dolomite grains that are very angular.

FIG. 4 is a photograph at 20× magnification of a sample from a well, containing fine grained particles with medium sphericity and angularity frac sand.

FIG. 5 is a photograph at 20× magnification of a sample from a well, containing very rounded, high sphericity frac sand.

FIG. 6 is a photograph at 10× magnification of a bimodal sample of very fine siltstone and clay, containing about 85% formation.

FIG. 7 is a photograph at 20× magnification of a subsample from FIG. 6 containing the very fine siltstone portion of the test sample.

FIG. 8 is a photograph at 20× magnification of a subsample from FIG. 6 containing the clay sized particles of the test sample.

FIG. 9 is a photograph at 10× magnification of subangular quartz proppant with medium sphericity and formation, containing about 20% quartz proppant and 75% formation.

FIG. 10 is a photograph at 20× magnification of a subsample from FIG. 9 of subangular quartz with medium sphericity, containing about 20% quartz proppant and 75% formation.

FIG. 11 is a photograph at 10× magnification of a sample from a wellbore containing about 45% frac sand, 5% cement, and 50% metal shavings.

FIG. 12 is a photograph at 20× magnification of a subsample from FIG. 11 frac sand.

FIG. 13 is a photograph at 20× magnification of a subsample from FIG. 11, containing cement.

FIG. 14 is a photograph at 20× magnification of a subsample from FIG. 11, containing metal shavings.

FIG. 15 is a photograph at 20× magnification of a sample from a wellbore, containing mostly salt.

FIG. 16 is a photograph at 20× magnification of a sample from a wellbore, containing metal shavings and paraffin.

FIG. 17 is a photograph at 20× magnification of a sample from a saltwater disposal facility and well, containing unidentified flakes.

FIG. 18 is a photograph of a coating of a well casing or tubing string.

FIG. 19 is a photograph of a pile of oil stained solids cleaned out from a producing unit.

FIG. 20 is a photograph of a beaker with 1 tablespoon of test sample solid material in a mixture of fresh water and dishwashing liquid in a beaker. The mixture has been gently stirred with a spoon and the hydrocarbon from the test sample has floated to the top of the fluid column.

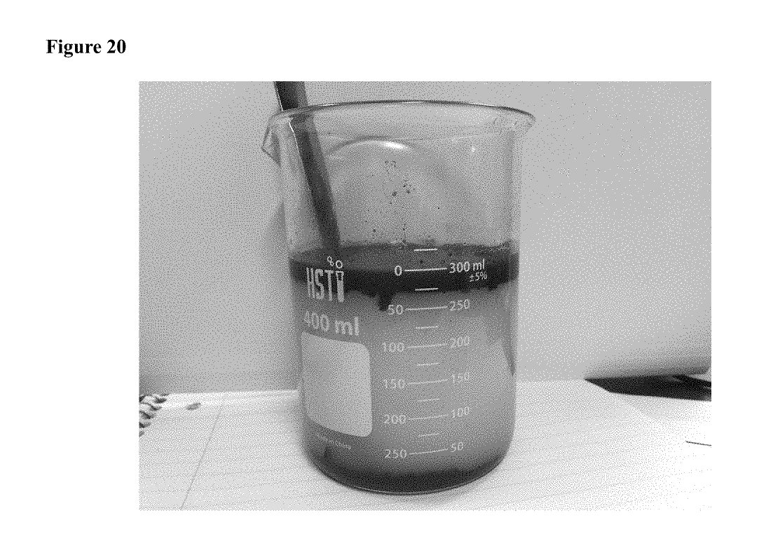

FIG. 21. Chart of process to collect test sample, prepare test sample and initial identification method.

FIG. 22. Chart of process to identify test sample components and estimate relative proportions within the test sample.

FIG. 23. Chart of process to collect physical sample data into a data base.

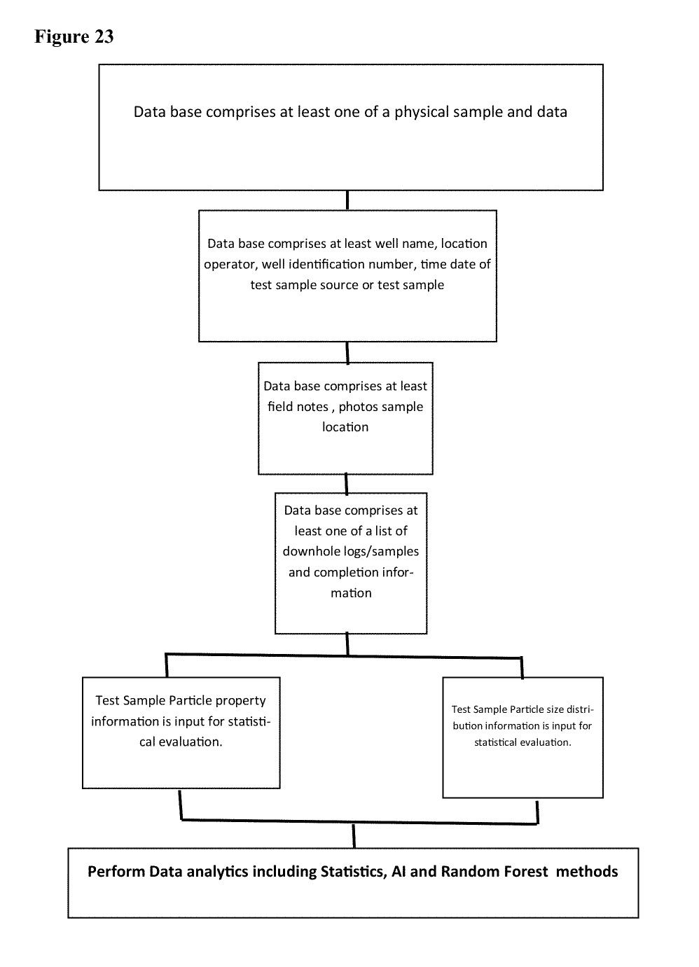

### DETAILED DESCRIPTION

Unless otherwise noted, all measurements are in standard metric units.

Unless otherwise noted, all instances of the words “a,” “an,” or “the” can refer to one or more than one of the word that they modify.

Unless otherwise noted, the phrase “at least one of . . . and” means one or more than one of an object. For example, “at least one of H₁ and H₂” means H₁, H₂, or both.

Unless otherwise noted, the term “about” refers to ±10% of the non-percentage number that is described, and rounded to the nearest whole integer. For example, about 100 mm, would include 90 to 110 mm. Unless otherwise noted, the term “about” refers to ±1% of a percentage number. For example, about 20% would include 19 to 21%. When the term “about” is discussed in terms of a range, then the term refers to the appropriate amount less than the lower limit and more than the upper limit. For example, from about 100 to about 200 mm would include from 90 to 220 mm.

Unless otherwise noted, all ranges include all intermediate integer numbers as well as the endpoints. For example, the range of 2% to 10% cement particles would be understood to include 2, 3, 4, 5, 6, 7, 8, 9, and 10% cement particles, and all numbers to the 10^{th} position between.

Unless otherwise noted, open ranges such as about “2% or more” cement particles are understood to have an upper limit of 100% cement particles.

Unless otherwise noted, the term “well” or “wellbore” refers to a well or wellbore that produces hydrocarbons, and was created by human activity. The term “well” or “wellbore” includes the well and its associated or connected formations that produce hydrocarbons.

Unless otherwise noted, the term “proppant” refers to any human-made proppant or graded, naturally-occurring sand used to keep a fracture open during or after a fracturing treatment.

A method of diagnosing a defect in a processing unit is disclosed. In an embodiment, the method includes obtaining a test sample from the processing unit, determining at least one property of particles in the test sample relative to a control sample, multiple control samples, a data base, or as a percent of the test sample, and diagnosing the defect in the processing unit. In an embodiment of the method, the processing unit includes at least one of a well, a wellbore, a wellbore completion string, a well formation, a well fracture, a well filter system, a well screen, a production facility screen, a chemical pipeline, a petroleum production facility, a chemical transportation vehicle, a chemical processing facility, fracture stimulation equipment, fracture storage tanks, tubing, flowlines, storage tanks, hoses and an injection disposal facility. In an embodiment, the processing unit is not limited so long as the processing unit processes or transports hydrocarbons or organic chemicals and can contain solid particles for analysis.

In an embodiment of the method, the step of determining is not generally limited so long as the step is capable of identifying or quantifying a property or aspect of a particle. In an embodiment, determining includes measuring, classifying, or observing a property of a particle using analytical techniques known in the art. In an embodiment, the step of determining can include analytical techniques, including at least one of microscopy, mass spectroscopy, nuclear magnetic spectroscopy, IR spectroscopy (Infrared spectroscopy), x-ray spectroscopy, gamma ray spectroscopy, XRF spectral gamma analysis (X-ray fluorescence), elemental analysis, XRD microscopy (X-ray diffraction), and UV-Vis spectroscopy (Ultraviolet-visible spectroscopy) to provide analytical data.

In an embodiment, the term “defect” can refer to a condition that stops or reduces production from the processing unit or can stop or reduce production if the defect is allowed to fully develop. In an embodiment, the method of diagnosing can include preventing, avoiding, or reducing the formation or symptoms of the defect. In an embodiment of the method, the method can include diagnosing, classifying, or pronouncing a cause of a defect. The term “diagnosing” refers to any method of communicating or recording a cause, theory, explanation, and/or classification of a defect in a processing unit. For example, a diagnosis can include an email or telephone call to an individual indicating that there is a failure to place proppant in the processing unit.

In an embodiment of the method, determining includes comparing at least one property of the test sample to a control sample, multiple control samples, or as a percentage of the test sample. In an embodiment, the control sample can be taken from formation in the area of the processing unit. In an embodiment, the control sample can be obtained from a vendor, or obtained from the processing unit before, during, or after the processing unit is performing a process. In an embodiment, determining includes comparing at least one property of the test sample to two or more test samples or a value obtained from more two or more test samples.

A method of diagnosing a defect in a hydraulic fracturing process is disclosed. In an embodiment, the method includes obtaining a test sample from at least one from the hydraulic fracturing process before, during, or after the hydraulic fracturing process, during the completion and/or a production process during a life of a processing unit; determining at least one property of proppant particles in the test sample relative to a control sample, wherein the control sample comprises a proppant sampled during fracture stimulation of a well bore or a standard sample of the proppant specified for a fracture stimulation of the well bore, wherein the test sample comprises solids which entered the hydraulic fracturing process, and diagnosing the defect in the hydraulic fracturing process. In an embodiment of the method, the property is at least one of a number, size, weight, geometry, sphericity, roundness, compressive strength, crushing strength, tensile strength, elastic modulus, yield stress, ductility, grain size, grain angularity, saturation, hardness, resistivity, porosity, grain density, bulk density, permeability, pressure, and temperature of the proppant particles.

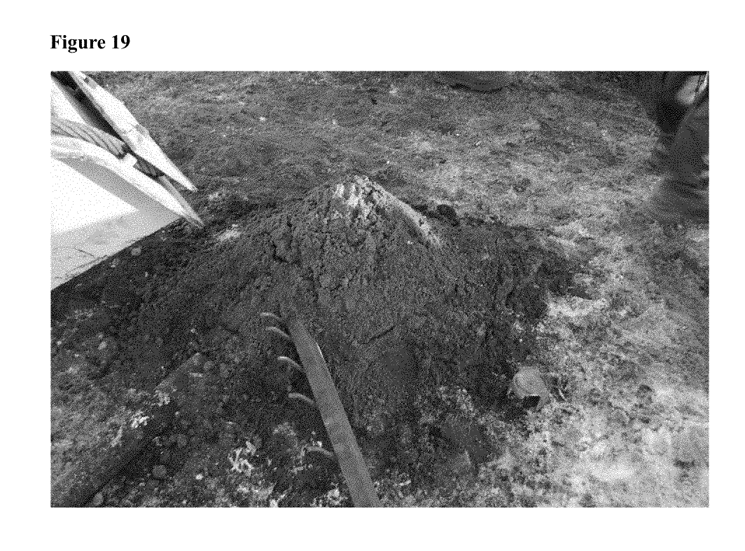

In an embodiment, the method provides an analytical procedure to determine various defects causing flow assurance problems within a processing unit. In an embodiment, the method also provides a procedure to examine recovered proppant and determine defects in fracture stimulation and proppant effectiveness over the life of the well. FIG. 19, shows a sample taken from a pile of clean out solids. The picture is a pile of solid material from a well clean out. This material is usually considered waste and not sampled. According to the method disclosed herein, this material can be sampled and analyzed to determine the cause of the solid build up or flow assurance issue.

A method of diagnosing a defect in a processing unit or hydraulic fracturing process is disclosed. In an embodiment, the method can include obtaining a control sample of solids before or during entry of the solids into the hydraulic fracking process or the processing unit. In an embodiment, the method can include obtaining a test sample from the processing unit during or after the processing unit performs a process. In an embodiment, the method can include measuring or analyzing multiple particles from the control sample and test sample for a property, such as particle size. In an embodiment, the method can include determining, by measuring and calculating, an average property for a control sample, including an average sphericity, average roundness, and/or average size of the control particles. In an embodiment, the method can include determining, by measuring and calculating, an average property for a test sample, including an average sphericity, average roundness, and/or average size of the test particles. In an embodiment, the method can include determining a change in a measurable or observable property of the particles by, for example, subtracting the average property for the control particles from the average property of the test particles.

For example, the method can include determining a change in average size by subtracting the average size of the control particles from the average size of the test particles to detect an increase, decrease, or a lack of statistically significant change in the average particle size. In an embodiment, the method can include determining a change in the number and/or percentage of particles in a sample having a property. For example, the method can include calculating an average number of particles in a control sample and test sample that are formation particles, metal particles, or salt particles. The method can include determining a change in the number, average number, or percentage of particles that are metal particles by, for example, subtracting a number, an average number, or percentage of metal particles in the control sample from a number, average number, or percentage of metal particles in the test sample. In an embodiment, the method can include diagnosing no change or a decrease of from about 1% to about 10% at least one of sphericity, roundness, and size of particles in a test sample as a failure to place proppant particles in a fracture by communicating this finding to a controller verbally, in writing, or by a signal.

### Sample Collection

In an embodiment, a sample is collected in the field and put into a sealable, liquid impermeable bag. Using a permanent marker, the bag ca be labeled with sample location information including country, state, county, well name, well identifying number, date of sample, and/or location at the processing unit where the sample was taken, and a description of the situation that caused the sample to be available for sampling. If possible, a photo of the sample site can also taken and the photo and test sample can be transmitted to the sample processing location. Once the test sample arrives at the sample processing site, the test sample and photo and any other accompanying information can be entered in a database that tracks the status and testing of the sample. The sample cam ne initially analyzed by weighing. Using a measuring spoon or other calibrated sampling tool, a measured amount of sub-sample cam be taken from the test sample. The remaining test sample can be saved for additional testing and retesting as required to determine the character of the test sample.

### Sub-Sample Processing

The sub-sample can be weighed using a calibrated scale. The sub-sample can be cleaned using one or all of a solvent, degreaser or soap. The free liquid can be removed from the cleaned sub-sample. The sub-sample can be dried by placing the sub-sample in a heat and fluid tolerant container like a glass beaker, and placing the container or beaker on a hot plate or by using slow convection heating equipment. Drying by slow heat or convection heat can be the preferred drying method over high volume air blowing or spinning dryers because those methods can impact the size and shape of the grains in the test sample. The sub-sample can be then weighed again. If there is significant sample loss the original sample can be evaluated for halite. If halite is detected, a second sub-sample can be taken and cleaned using a process to preserve the halite.

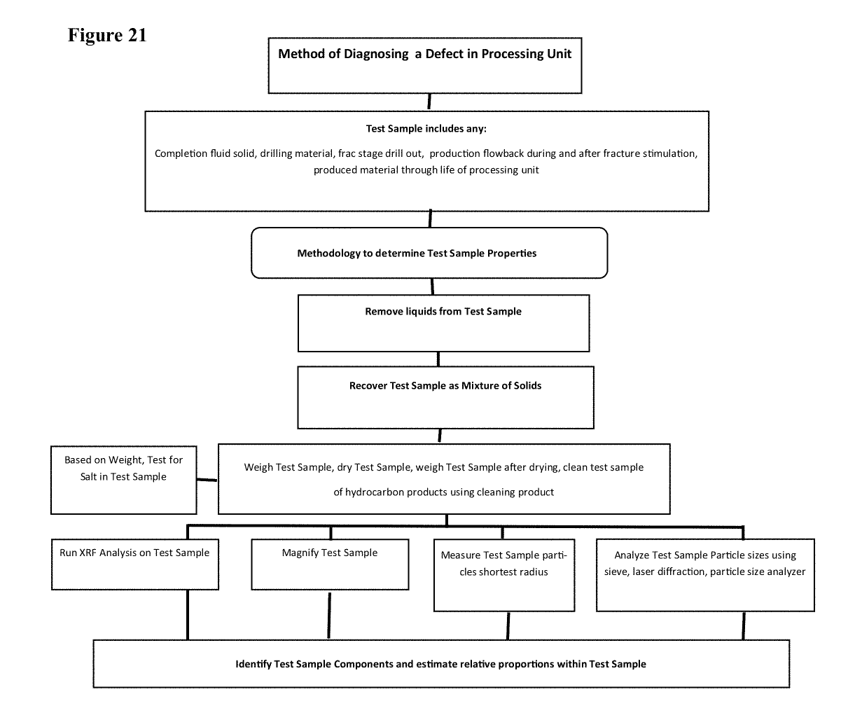

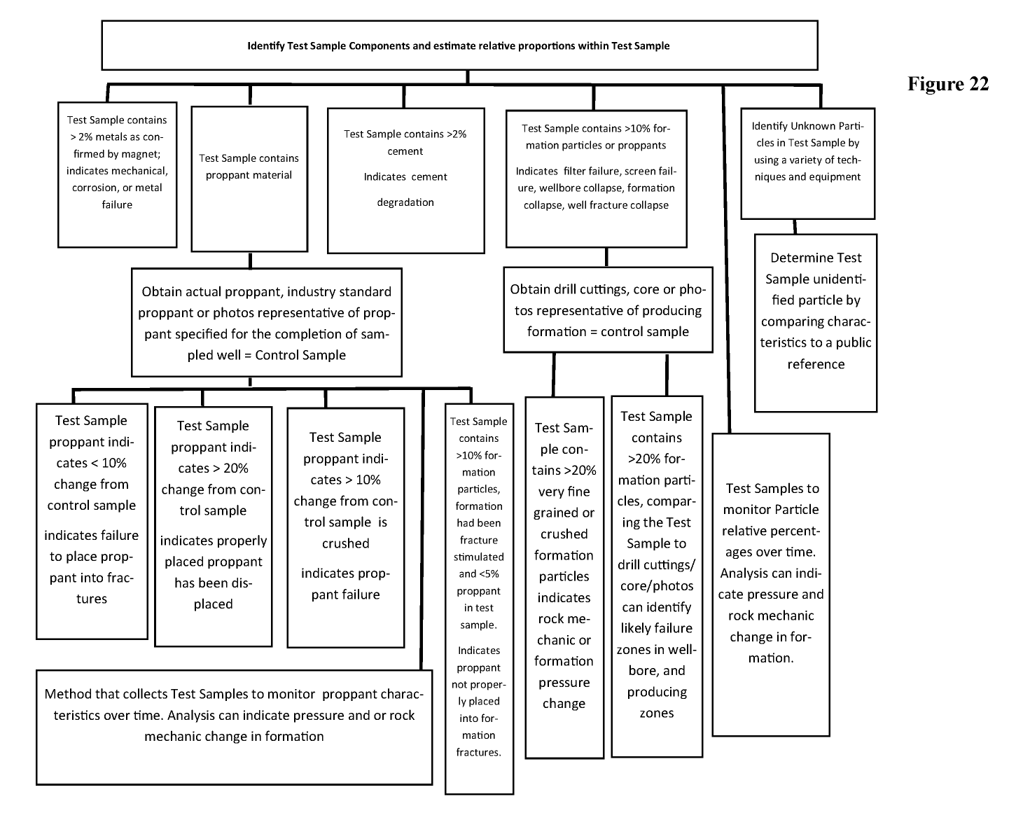

The clean, dry sub-sample can be next examined using magnification. The grain sizes, sphericity and roundness of the particles are described. The smallest radius of the grains can be measured or estimated. The sub-sample can also be evaluated using an XRF analysis to determine elemental components. FIG. 21 is a summary of the process to collect, clean and perform the initial sample identification. Additional analysis performed to identify specific particles in the sub-sample and to estimate the relative percentages of the particles in the sub-sample are presented in FIG. 22. A magnet can be run over and under the test sample to detect the presence of metals. The sub-sample can be examined for specific particles such as proppant, cement, formation particles, and unknown particles.

If proppant is detected then the percentages of proppant in the sub-sample are estimated, the proppant can be described for roundness and sphericity. To compare the sub-sample with the original proppant placed in the wellbore, actual proppant used to frac the well is obtained during the completion process.

If actual proppant was not obtained, then industry standard proppant for the proppant specified in the completion of the well can be used to compare with recovered proppant. Comparing the recovered proppant to the control sample proppant can indicate if proppant was effectively placed in fractures and proppant change over time can indicate pressure and rock mechanic change in the formation as the hydrocarbons are produced.

If recovered drill cuttings, core, photos, or digital images representative of the producing formation are obtained, they can be used as a control sample for comparison with the test sample formation. Comparing the recovered formation with the control sample formation can identify likely failure zones and producing zones in the wellbore. If the recovered formation is crushed compared to the control sample this can indicate rock mechanic or formation pressure change over time.

### Statistical Methods

Another statistical method can include comparing the sphericity and roundness of the control and test samples. Sphericity and Roundness are dimensionless measurements and are independent of size. The Sphericity of a particle is a measure of the degree to which the particle approximates the shape of a sphere. The measurement of the sharpness of a particle's edges and corners is the Roundness. Surface area, size of particles in three dimensions and volume calculations are also measurements that can be determined for both control and test samples. Recent advancements in Particle Size Analyzers that can measure these values quickly and accurately make this type of measurement available when in the past the values could not be measured either due to time or economic constraints, or the lack of equipment capabilities to measure extremely small particles. The sphericity index of an object is defined as the sphericity of the object (calculated as the surface area of the particle) relative to the surface area of a sphere with the same volume as the particle, (Cruz-Marias, 2013). See, Cruz-Matias, I. and D. Ayala, 2013, Orientation, Sphericity and Roundness Evaluation of Particles Using Alternative 3D Representations, University of Politenica de Catalunya, Barcelona, Spain, 29 pages. The statistical method for comparing Sphericity can be modified by comparing the measured sphericity of the test sample relative to the control sample. Because control samples in this application are proppant which are not always perfect spheres, this comparison is more valuable to determine if certain types of proppant under certain conditions fail more consistently. Chernoff (1971) also described a method to compare three dimensional relationships of particles for statistical analysis to determine changes over time that can be applied to the control and test samples. See, Chernoff, H., 1971, The Use of Faces to Represent Points in n-Dimensional Space Graphically, Technical Report Number 71 for the Office of Naval Research, Dec. 27, 1971, 49 pages.

Another statistical method can include Random Forest multivariant analysis as described by Duda et al., 2002, and as applied by Dalthorp et al. 2012. See, Duda, R. O., P. E. Hart and D. G. Stork, Pattern Classification, 2001, New York, Wiley & Sons, Inc., 637 pages; and Dalthorp, M., T. H. Naehr, P. Tissot, O. Garcia-Pineda, 2013, Relationship of Subsurface Reservoir Properties and Hydrocarbon Sea-surface Slicks in the Northern Gulf of Mexico, in Fred Aminzadeh, Timothy Berge and David L. Connolly, eds., Hydrocarbon Seepage: From Source to Surface; Society of Exploration Geophysicists and American Association of Petroleum Geologists, Geophysical Developments Number 16, pages 185 to 198. The application of this data analytical approach in this method utilizes a dataset of properties including physical, chemical and geological qualities associated with wellbores and production units. These properties are then compared with measured results of test particles through a decision tree predictor model that provides an estimation of what type of properties may contribute to (or predict), the measured results in test particles. For example, a certain reservoir temperature and pressure may be a predictor of proppant failures. Proppant types are currently broadly specified according to expected pressures and temperatures. By providing additional properties such as reservoir mineral composition or porosity these proppant specifications can be customized for specific application which can result in cost efficiency and can possibly prevent failures in the producing unit.

This application describes the creation of a database of properties through a systematic process of collecting and measuring solids in the wellbore and producing unit. This database can be used to perform statistical analysis as described by Townend (2002) and applied by Dalthorp (2011) to determine correlated properties and relationships through a variety of analysis including principal component analysis, cluster analysis, Spearman's rank correlation and Pearson rank correlations. See, Townend, J., 2002, Practical Statistics for Environmental and Biological Scientists, West Sussex, Wiley, 270 pages; and Dalthorp, M., 2011, The Geology of Gulf of Mexico Hydrocarbon Seeps: Structural and Stratigraphic Relationships of Hydrocarbon Seeps in the Gulf of Mexico and the Geological Factors Contributing to Sea Surface Oil Slick Formation, Dissertation Texas A&M University—Corpus Christi, Tex., 162 pages. This analysis may help determine success or failure within a producing unit or wellbore.

### EMBODIMENTS OF THE DISCLOSURE

Embodiment 1. A method of diagnosing a defect in a processing unit comprising:

obtaining a test sample from the processing unit, wherein the processing unit comprises at least one of a wellbore, a wellbore completion string, a well formation, a well fracture, a well filter system, a well screen, a production facility screen, a chemical pipeline, a petroleum production facility, a chemical transportation vehicle, a chemical processing facility, fracture stimulation equipment, fracture storage tanks, tubing, flowlines, storage tanks, hoses and an injection disposal facility;

determining at least one property of particles in the test sample relative to a relative to a control sample, multiple control samples, or as a percent of the test sample,

wherein the test sample comprises solids which entered the processing unit and

wherein the property is at least one of a number, size, weight, geometry, sphericity, roundness, compressive strength, crushing strength, tensile strength, elastic modulus, yield stress, ductility, grain size, grain angularity, saturation, hardness, resistivity, porosity, grain density, bulk density, permeability, digital image comparison, pressure, and temperature of the particles; and

diagnosing the defect in the processing unit.

Embodiment 2. The method of embodiment 1 comprising, diagnosing the defect in the processing unit as a mechanical issue or corrosion or undiagnosed source of metal fragments in the processing unit when about 2% or more of metal particles relative to a total distribution of the test sample are detected.
Embodiment 3. The method of any one of embodiments 1-2 comprising, diagnosing the defect in the processing unit with cement degradation when about 2% or more of cement particles relative to a total distribution of the test sample are detected.
Embodiment 4. The method of any one of embodiments 1-3 comprising, diagnosing the defect in the processing unit with at least one of filter failure, screen failure, wellbore collapse, formation collapse, and well fracture collapse when about 10% or more of formation particles or proppants relative to a total distribution of the test sample is determined.
Embodiment 5. The method of any one of embodiments 1-4, wherein the test sample comprises at least one of a completion solid sample material, a completion flow back material, or a drilling material during frac stage drill outs, production solid sample obtained any time throughout a life of the processing unit, or a production flow back sample during and after fracture stimulation.
Embodiment 6. The method of any one of embodiments 1-5, wherein the test sample comprises a mixture of solids, liquids and gas.
Embodiment 7. The method of any one of embodiments 1-6, wherein a liquid is removed from the test sample before determining the at least one property of the particles relative to the total distribution of the test sample is detected.
Embodiment 8. The method of any one of embodiments 1-7, wherein the at least one property of the particles is determined by examining the test sample by magnified imaging and recording digital images.
Embodiment 9. The method of any one of embodiments 1-8, wherein the at least one property of the particles is determined by passing the particles through at least one sieve, by a laser diffraction technique, or by a particle size analyzer.
Embodiment 10. The method of any one of embodiments 1-9, wherein the size of the particles is determined by measuring a shortest radius of at least one particle.
Embodiment 11. The method of any one of embodiments 1-10, further comprising,

determining at least one of a type, a material, or an origin of an unidentified particle by analyzing the unidentified particle by at least one of mass spectroscopy, nuclear magnetic spectroscopy, IR spectroscopy, x-ray spectroscopy, gamma ray spectroscopy, XRF spectral gamma analysis, elemental analysis, XRD microscopy, and UV-Vis spectroscopy to provide analytical data.

Embodiment 12. The method of any one of embodiments 1-11, further comprising,

determining at least one of the type, the material, or the origin of the unidentified particle by data matching at least one property of the unidentified particle to a material profile in a publicly or privately available data resource and/or by digital image recognition.

Embodiment 13. The method of any one of embodiments 1-12 or 20-25, wherein the data resource comprises at least one of a physical sample and data from a physical sample.
Embodiment 14. The method of any one of embodiments 1-13 or 20-25, where the data resource comprises cased and open hole logs, mud logs, Logging While Drilling (LWD) logs, downhole imaging logs, directional survey logs, well fluid and pressure sampling, well completion information, core analysis and photos, cuttings, sidewall cores analysis, and data acquired under downhole well conditions.
Embodiment 15. The method of any one of embodiments 1-14 or 20-25 comprising,

diagnosing the defect in the processing unit with at least one of well completion failure, filter failure, screen failure, wellbore collapse, formation collapse, and well fracture collapse when an increase of formation particles of from about 20% or more relative to the total distribution of the test sample is determined, and then

identifying a formation weakness location in the wellbore by determining a correlation between sample formation particles to drill cuttings control samples from the wellbore.

Embodiment 16. The method of any one of embodiments 1-15 or 20-25, further comprising,

recording or documenting the data, wherein the data comprises at least one of a field note, a photograph of a sample location, well site information, processing unit information, wellbore information, completion history, production history, sample method, and the at least one property of the particles, and

determining potential future defects and timing of potential defects such as refracturing needs or wellbore remediation by performing statistical or mathematical modeling based on the data.

Embodiment 17. The method of any one of embodiments 1-16 or 20-25, wherein the well site information comprises at least one of:

a well name, a well location, a name of a well operator, a well identifying number, a date, a time of obtaining the test sample, and a source of the test sample.

Embodiment 18. The method of any one of embodiments 1-17 or 20-25, further comprising,

sending a request for at least one of a graphical particle size log and a particle size versus percentile estimation from the data resource to an administrative processor.

Embodiment 19. The method of any one of embodiments 1-18 or 20-25, further comprising,

sending a request for an input of the at least one properties of the particles from the data resource to an administrative processor.

Embodiment 20. A method of diagnosing a defect in a hydraulic fracturing process comprising:

obtaining a test sample from at least one of the hydraulic fracturing process before, during, or after the hydraulic fracturing process, during the completion and production process during a life of a processing unit;

determining at least one property of proppant particles in the test sample relative to a control sample,

wherein the control sample comprises a proppant sampled during fracture stimulation of a well bore or a standard sample of the proppant specified for a fracture stimulation of the well bore,

wherein the test sample comprises solids which entered the hydraulic fracturing process and

wherein the property is at least one of a number, size, weight, geometry, sphericity, roundness, compressive strength, crushing strength, tensile strength, elastic modulus, yield stress, ductility, grain size, grain angularity, saturation, hardness, resistivity, porosity, grain density, bulk density, permeability, pressure, and temperature of the proppant particles; and

diagnosing the defect in the hydraulic fracturing process.
Embodiment 21. The method of embodiment 20 comprising,

diagnosing the defect in the hydraulic fracturing process as a failure to place the proppant particles into a fracture when a number of proppant particle properties does not change or decreases from about 1% to about 10% relative to the control sample.

Embodiment 22. The method of embodiment 20 comprising,

determining an increase of from about 20% or more of proppant particles exhibiting a change in a least one of sphericity, roundness, and size relative to the control sample, and

diagnosing the defect in the hydraulic fracturing process, completion design, or production drawdown plan as displacement of placed proppant.

Embodiment 23. The method of embodiment 20 comprising,

determining an increase of from about less than 5% of proppant particles and greater than 10% of formation, and provided that the formation was fracture stimulated, the absence of proppant in the test sample, and

diagnosing the defect in the hydraulic fracturing process as a failure to place proppant into a fracture in a wellbore, a well formation, or a well fracture during or after the hydraulic fracturing process.

Embodiment 24. The method of embodiment 20 comprising,

determining an increase of from about 10% to about 100% of crushed proppant particles relative to the control sample, and

diagnosing the defect in the hydraulic fracturing process as at least one of unsuitable proppant, unsuitable proppant transport fluid, excessive pressure, and effective stress in a wellbore, a formation, or a fracture during or after the hydraulic fracturing process.

Embodiment 25. The method of embodiment 20 comprising,

determining an erosion or a corrosion of the proppant over time by comparing a change of at least one property of sphericity, roundness, size, and compressive strength, or other recorded, estimated, or predicted property to the control sample and optionally two or more samples obtained during production, or before, during or after the hydraulic fracturing stimulation and

diagnosing the proppant material change as an indicator of a pressure or rock mechanic change in the formation.

Embodiment 26. The method of any one of embodiments 1-18 or 20-25 comprising,

diagnosing the defect in the processing unit with at least one of changes in rock mechanics, formation pore pressure, or effective stress when greater than 20% of formation particles relative to a total distribution of the test sample are fine grained or crushed.

Embodiment 27. The method of any one of embodiments 1-18 or 20-25 comprising,

determining the erosion or compaction of the formation over time by comparing a change of relative percentages of particles in test samples, and

diagnosing the producing unit and formation rock property variations.
Embodiment 28. The method of any one of embodiments 1-18 or 20-25 comprising, diagnosing the defect in the processing unit as a formation producing issue when about 10% or more of Halite (NaCl) as a solid relative to a total distribution of the test sample is detected.
Embodiment 29. The method of any one of embodiments 1-18 or 20-25, wherein the at least one property of the particles is determined by examining the test sample by XRF analysis.

### EXAMPLES

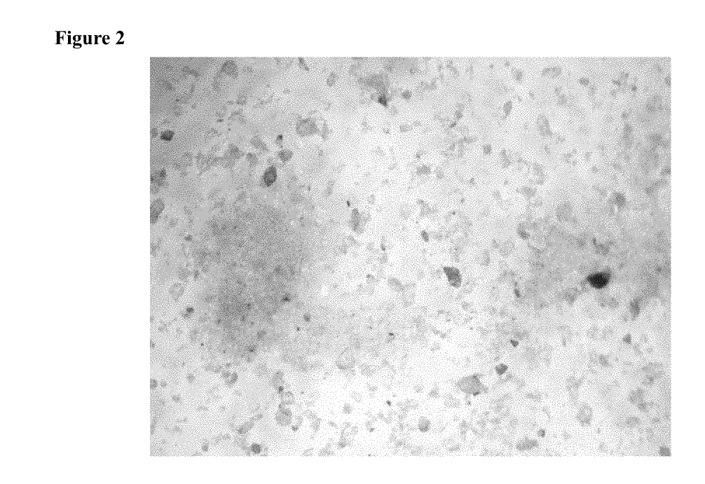

The test sample in FIG. 2 was taken from a well with a rod pump that had sanded off in the tubing. Solid particulates had pulled up through the desander, through the pump and fell back around the outside (OD) of the pump barrel. The test sample was taken from the material between the rod pump and the tubing. The well was completed in the Middle Bakken formation, with a lateral drilled to a total depth of 19,521 feet that was fracture stimulated June 2010 with 40-70 frac sand and 31,338 barrels of fluid with a maximum treatment pressure of 8164 psi, and maximum injection rate of 60.2 bbls/minute (barrel of oil per minute).

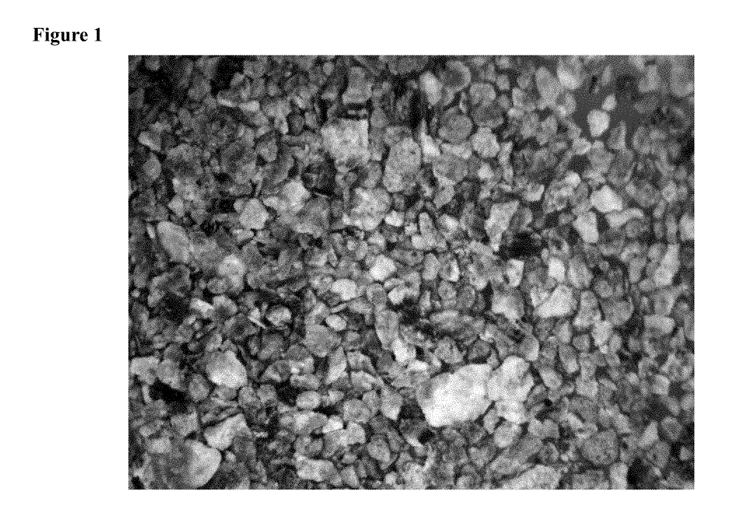

The test sample was taken and delivered to the analysis facility September 2013. The test sample was cleaned and dried. The solid material was evaluated under magnification and was determined to be very fine grained, powder like grains with low to mild sphericity, that were sub angular to very angular. The cuttings from the lateral were examined to compare with the test sample. The comparison of the test sample in FIG. 2 and the drill cuttings in FIG. 1 which were fine to med size dolomite grains, indicated that the test sample contained no formation and was frac sand that had been crushed. The determination of crush is defined as having equal to or more than 10% of the frac sand smaller than the smallest mesh size of the proppant used in the fracture stimulation. The analysis indicated that the flow assurance problem was caused by frac sand and the recovered sand had been crushed from the original 40-70 frac sand to a very fine particle size. The recommendation to remedy the flow assurance problem was to redesign the desander and filters to accommodate the very fine frac sand. The well was also identified as a possible re-frac candidate because the crushed proppant indicates the original fracture stimulation may not have been effective.

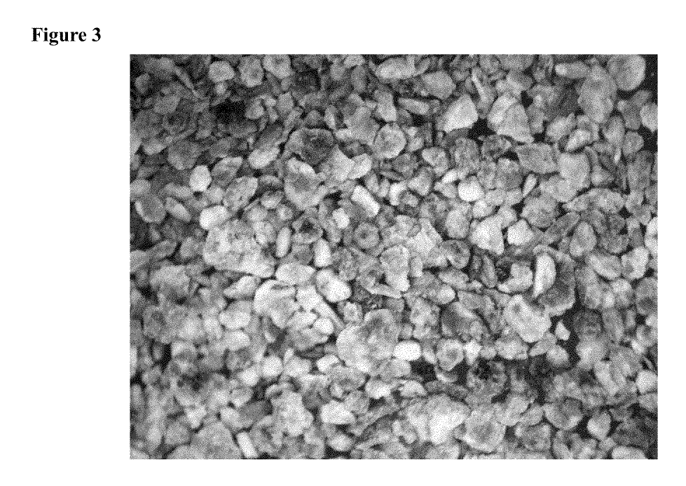

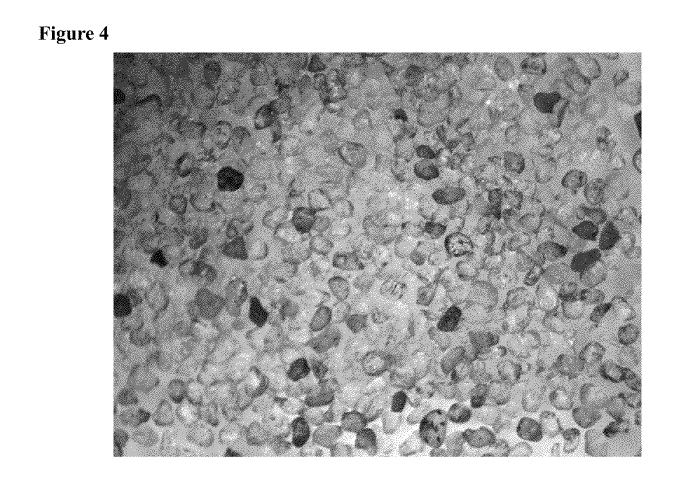

The test sample in FIG. 4 was taken from a well producing with a rod pump and experiencing flow assurance problems. The test sample was taken from the pump jack. The well was completed in the Middle Bakken formation with a lateral drilled to a total depth of 18,870 feet that was fracture stimulated June 2010 with 40-70 frac sand and 25,491 barrels of fluid with a maximum treatment pressure of 5673 psi, and maximum injection rate of 28.9 bbls/minute. The test sample was cleaned and dried. The solid material in the test sample was evaluated under magnification and was determined to be fine grained frac sand with medium sphericity and angularity. The cuttings from the lateral were examined to compare with the test sample. The comparison of the test sample and the drill cuttings in FIG. 3 which are fine to med size dolomite grains, indicated that the test sample contained no formation and was all frac sand. The frac sand medium sphericity and angularity indicated that the frac sand had most likely been successfully placed in a fracture, but had mobilized back into the wellbore. This could indicate interference from an offset frac or possibly producing the wellbore too aggressively.

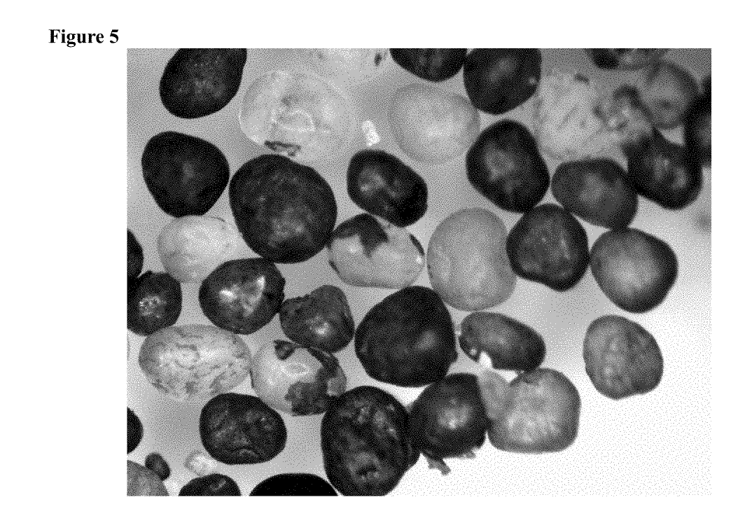

The test sample FIG. 5 was taken from a well producing with a rod pump and experiencing flow assurance problems. The test sample was taken from the tail joints. The well was completed in the Middle Bakken formation with a lateral drilled to a total depth of 20,220 feet that was fracture stimulated June 2012 with 40-70 frac sand and 72,594 barrels of fluid with a maximum treatment pressure of 8633 psi, and maximum injection rate of 36.0 bbls/minute. The test sample was cleaned and dried. The solid material in the test sample was evaluated under magnification and was determined to be fine grained frac sand with high sphericity and low angularity. The test sample contained no formation and was all frac sand. The frac sand high sphericity and low angularity indicated that the frac sand had most likely never been successfully placed in a fracture. To address the flow assurance issue of frac sand proppant in the wellbore, a clean out of the wellbore and redesign of the desander was recommended.

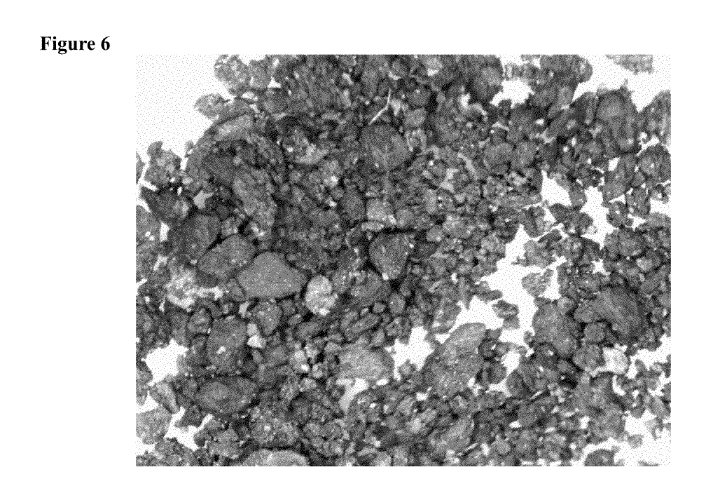

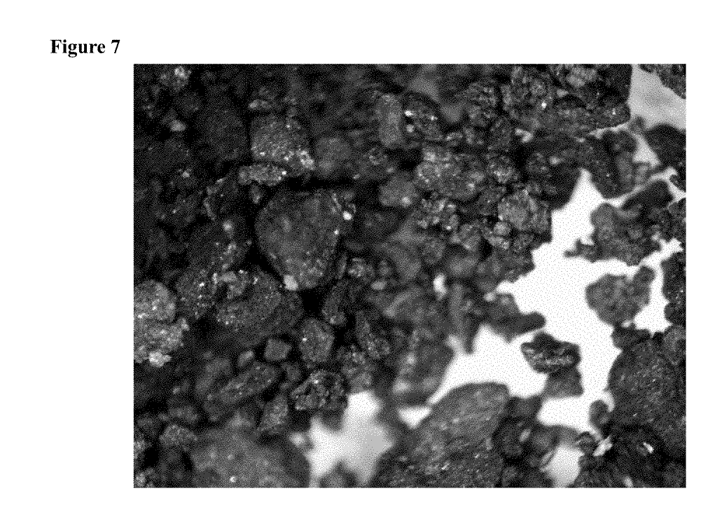

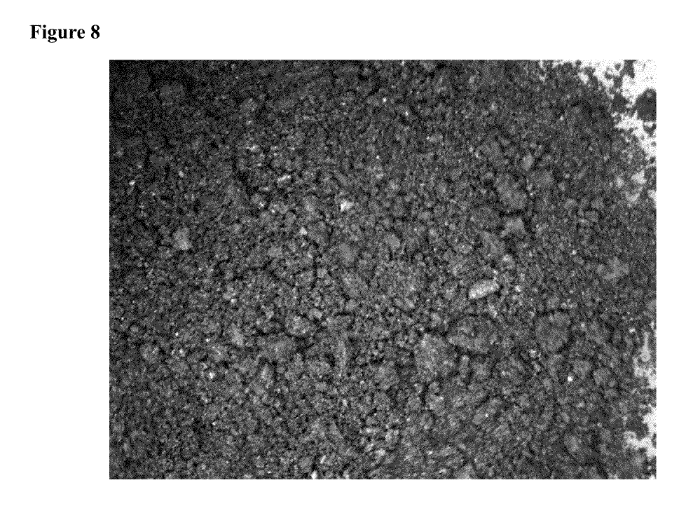

The test sample in FIG. 6 was taken from a well experiencing flow assurance problems. The test sample was taken outside the excluder screen. The well was completed in the Middle Bakken formation with a lateral drilled to a total depth of 20,220 feet that was fracture stimulated January 2007 with 401,501 lbs of 40-70 premium white frac sand and 11,387 barrels of fluid with a maximum treatment pressure of 5275 psi, and maximum injection rate of 61 bbls/minute. The test sample was cleaned and dried. The solid material in the test sample was evaluated under magnification and was determined to be 85% formation. The test sample contained 10% frac sand. Two distinct grain sizes of formation were identified, very fine siltstone in FIG. 7 and clay sized particles in FIG. 8. To address the flow assurance issue of solids in the wellbore, a clean out of the wellbore and redesign of the desander to accommodate the very fine and clay sized formation particles was recommended.

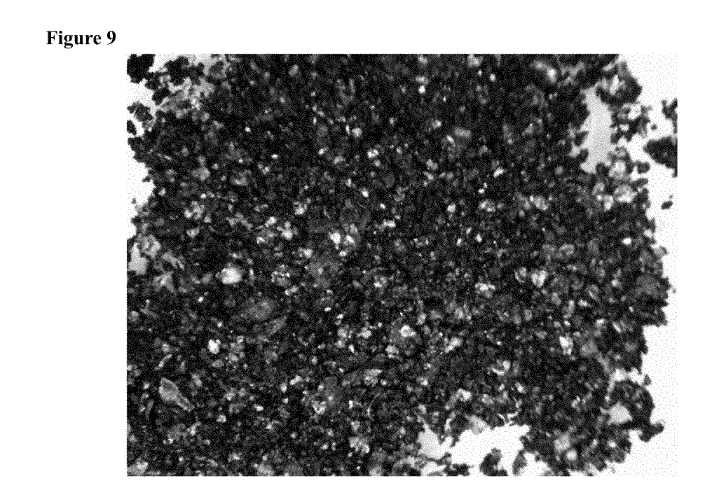

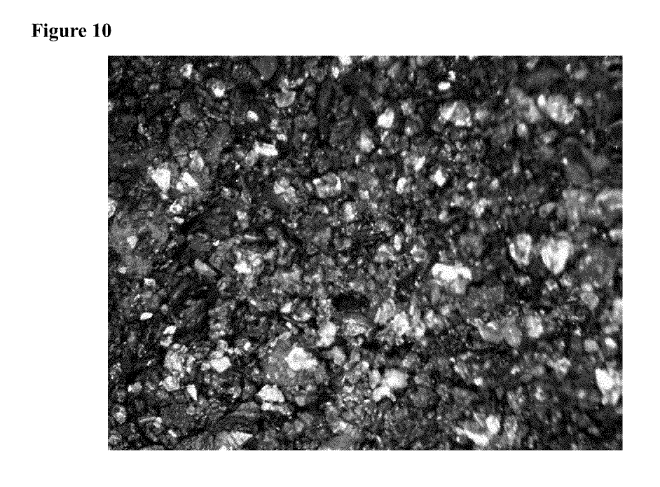

The test sample in FIGS. 9 and 10 was taken from a well experiencing flow assurance problems. The test sample was taken from the tailpipe. The well was completed in the Three Forks formation with a lateral drilled to a total depth of 18,158 feet that was fracture stimulated April 2013 with 2,848,440 lbs of 40-70 premium white frac sand and 11,387 barrels of fluid with a maximum treatment pressure of 8,291 psi, and maximum injection rate of 46.8 bbls/minute. The test sample was cleaned and dried. One tablespoon of the pre-cleaned test sample weighed 28.72 g and weighed 2.81 g after washing, which is indicative of salt in the original sample. The remaining solid material in the test sample was evaluated under magnification and was determined to be 75% formation that was clay sized particles. The test sample contained 20% frac sand. The frac sand was sub-angular with medium sphericity, which indicates the proppant was successfully placed into fractures. To address the flow assurance issue of solids in the wellbore, a clean out of the wellbore and redesign of the desander to accommodate the very fine and clay sized formation particles was recommended. A fresh water flush of the wellbore and system was also recommended to remove the salt in the system.

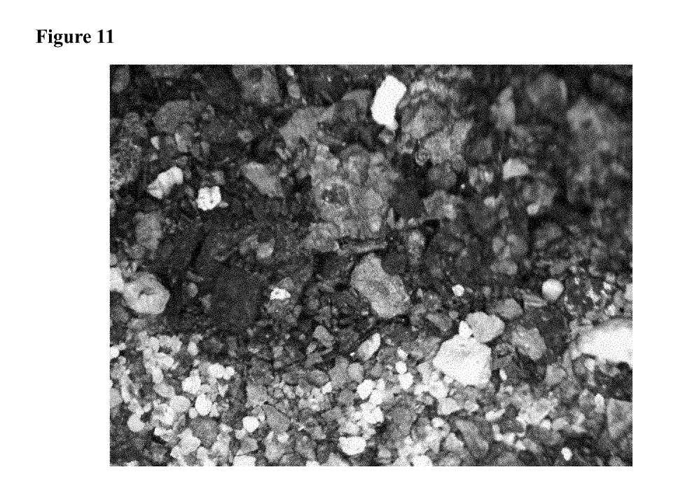

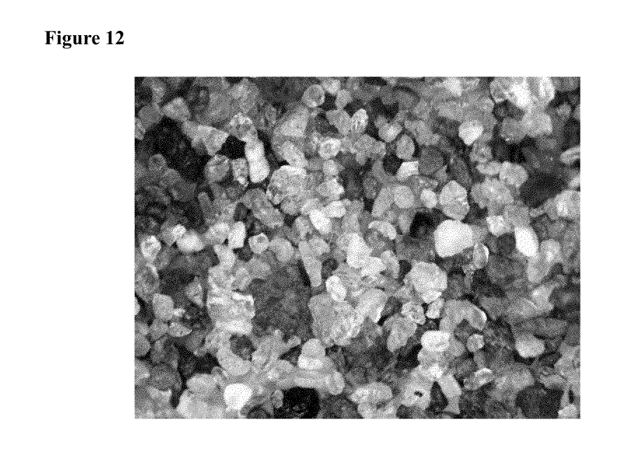

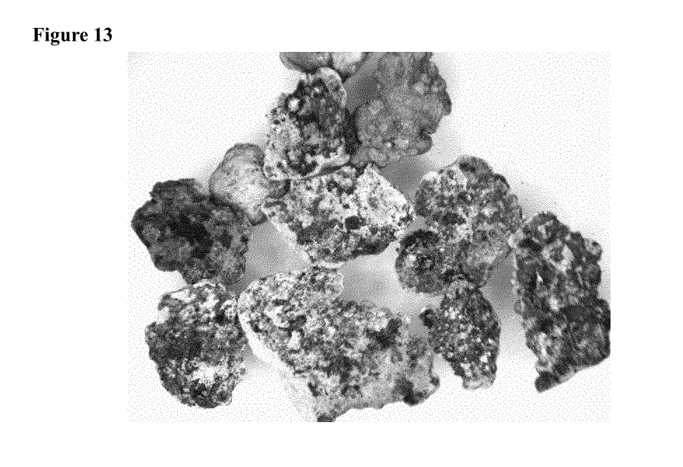

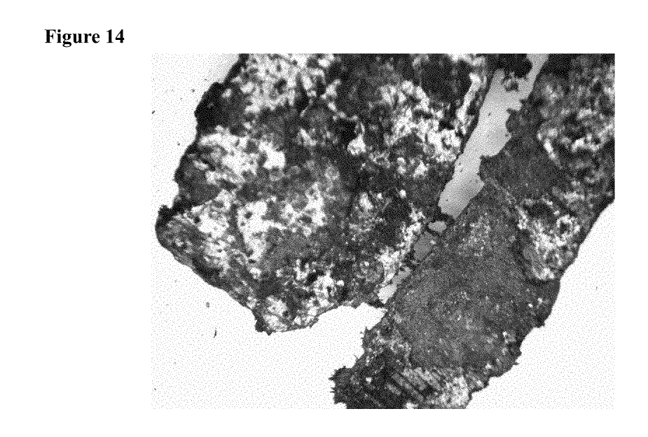

The test sample in FIG. 11 was taken from a well experiencing flow assurance problems. The test sample was taken from a tail joint. The well was completed in the Middle Bakken formation with a lateral drilled to a total depth of 19,250 feet that was fracture stimulated December 2011 with 2,913,750 lbs of 40-70 frac sand, a maximum treatment pressure of 6,679 psi, and maximum injection rate of 59.2 bbls/minute. The test sample was cleaned and dried. One tablespoon of the pre-cleaned test sample weighed 26.27 g and weighed 1.39 g after washing, which is indicative of salt in the original sample. The remaining solid material in the test sample was evaluated under magnification and was determined to be 50% metal shavings as indicated in FIG. 14; 45% frac sand as indicated in FIG. 12; and 5% cement as indicated in FIG. 13. The frac sand was sub-angular with medium sphericity, which indicates the proppant was placed into fractures. To address the flow assurance issue of solids in the wellbore, a workover of the wellbore to determine the area of cement issues and metal wear was recommended. A fresh water flush of the wellbore and system was also recommended to remove the salt in the system.

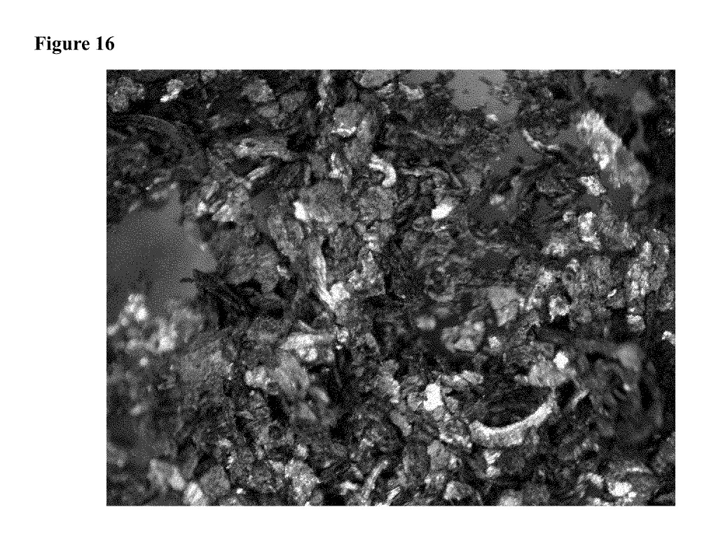

The test sample in FIG. 16 was taken from a well experiencing flow assurance problems. The test sample was taken from the rod pump. The well was completed in the Middle Bakken formation with a lateral drilled to a total depth of 19,150 feet that was fracture stimulated December 2011 with 2,937,338 lbs of 40-70 frac sand and 50,156 barrels of fluid with a maximum treatment pressure of 6,479 psi, and maximum injection rate of 25.5 bbls/minute. The test sample was cleaned and dried. The sample was determined to be very fine metal shavings and paraffin. To address the flow assurance issue of solids in the wellbore, a workover of the wellbore to treat for paraffin was recommended and the source of the metal wear be determined and remedied.

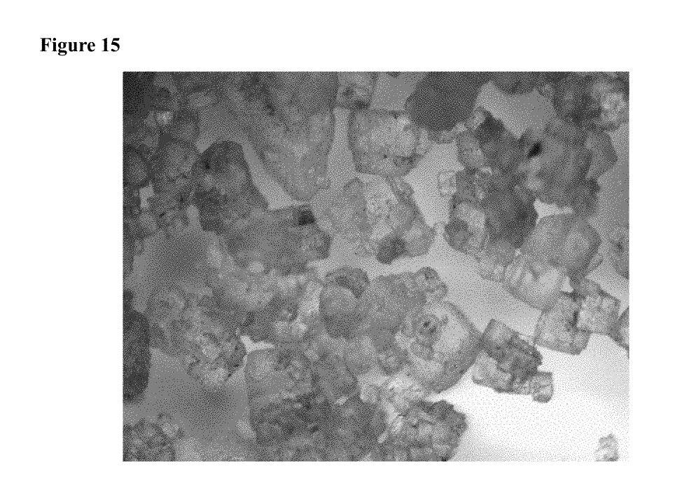

The test sample in FIG. 15 was taken from a well experiencing flow assurance problems. The test sample was taken from just above the bottom hole assembly. The well was completed in the Three Forks formation with a lateral drilled to a total depth of 18,795 feet. The test sample was cleaned and dried. One tablespoon of the pre-cleaned test sample weighed 15.38 g and was totally gone after washing, which is indicative of salt in the original sample. A fresh water flush of the wellbore and system was also recommended to remove the salt in the system.

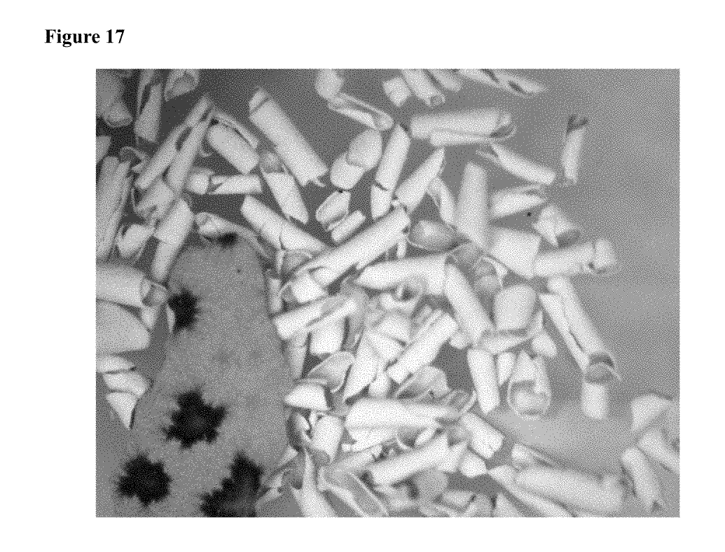

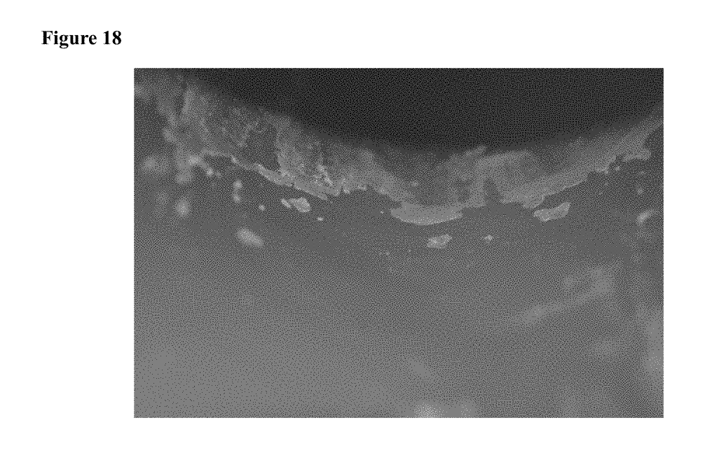

The test sample in FIG. 17 was taken from a saltwater disposal facility experiencing flow assurance problems. The test sample was taken from inside the tubing of the saltwater disposal well. The test sample was cleaned and dried. The test sample contained glossy brown flakes with an opposite side that is beige coloring with grey markings. After cleaning with an acid wash, the flakes became white. The source of the flakes was initially unknown. After further investigation, the source of the flakes was determined to be from a coating on the storage tank at the facility and from the coating on the inside of the casing or tubing, FIG. 18.

What is claimed is:

1. A method of diagnosing a defect in a processing unit comprising:
obtaining a test sample from the processing unit, wherein the processing unit comprises at least one of a wellbore, a wellbore completion string, a well formation, a well fracture, a well filter system, a well screen, a production facility screen, a chemical pipeline, a petroleum production facility, a chemical transportation vehicle, a chemical processing facility, fracture stimulation equipment, fracture storage tanks, tubing, flowlines, storage tanks, hoses and an injection disposal facility;
determining at least one property of particles in the test sample relative to a relative to a control sample, multiple control samples, or as a percent of the test sample,
wherein the test sample comprises solids which entered the processing unit and
wherein the property is at least one of a number, size, weight, geometry, sphericity, roundness, compressive strength, crushing strength, tensile strength, elastic modulus, yield stress, ductility, grain size, grain angularity, saturation, hardness, resistivity, porosity, grain density, bulk density, permeability, digital image comparison, pressure, and temperature of the particles; and
diagnosing the defect in the processing unit.

2. The method of claim 1 comprising, diagnosing the defect in the processing unit as a mechanical issue or corrosion or undiagnosed source of metal fragments in the processing unit when about 2% or more of metal particles relative to a total distribution of the test sample are detected.

3. The method of claim 1 comprising, diagnosing the defect in the processing unit with cement degradation when about 2% or more of cement particles relative to a total distribution of the test sample are detected.

4. The method of claim 1 comprising, diagnosing the defect in the processing unit with at least one of filter failure, screen failure, wellbore collapse, formation collapse, and well fracture collapse when about 10% or more of formation particles or proppants relative to a total distribution of the test sample is determined.

5. The method of claim 1, wherein the test sample comprises at least one of a completion solid sample material, a completion flow back material, or a drilling material during frac stage drill outs, production solid sample obtained any time throughout a life of the processing unit, or a production flow back sample during and after fracture stimulation.

6. The method of claim 1, wherein the test sample comprises a mixture of solids, liquids and gas.

7. The method of claim 1, wherein a liquid is removed from the test sample before determining the at least one property of the particles relative to the total distribution of the test sample is detected.

8. The method of claim 1, wherein the at least one property of the particles is determined by examining the test sample by magnified imaging and recording digital images.

9. The method of claim 1, wherein the at least one property of the particles is determined by passing the particles through at least one sieve, by a laser diffraction technique, or by a particle size analyzer.

10. The method of claim 1, wherein the size of the particles is determined by measuring a shortest radius of at least one particle.

11. The method of claim 1, further comprising,
determining at least one of a type, a material, or an origin of an unidentified particle by analyzing the unidentified particle by at least one of mass spectroscopy, nuclear magnetic spectroscopy, IR spectroscopy, x-ray spectroscopy, gamma ray spectroscopy, XRF spectral gamma analysis, elemental analysis, XRD microscopy, and UV-Vis spectroscopy to provide analytical data.

12. The method of claim 11, further comprising,
determining at least one of the type, the material, or the origin of the unidentified particle by data matching at least one property of the unidentified particle to a material profile in a publicly or privately available data resource and/or by digital image recognition.

13. The method of claim 12, wherein the data resource comprises at least one of a physical sample and data from a physical sample.

14. The method of claim 12, where the data resource comprises cased and open hole logs, mud logs, Logging While Drilling (LWD) logs, downhole imaging logs, directional survey logs, well fluid and pressure sampling, well completion information, core analysis and photos, cuttings, sidewall cores analysis, and data acquired under downhole well conditions.

15. The method of claim 1 comprising,
diagnosing the defect in the processing unit with at least one of well completion failure, filter failure, screen failure, wellbore collapse, formation collapse, and well fracture collapse when an increase of formation particles of from about 20% or more relative to the total distribution of the test sample is determined, and then
identifying a formation weakness location in the wellbore by determining a correlation between sample formation particles to drill cuttings control samples from the wellbore.

16. The method of claim 13, further comprising,
recording or documenting the data, wherein the data comprises at least one of a field note, a photograph of a sample location, well site information, processing unit information, wellbore information, completion history, production history, sample method, and the at least one property of the particles, and
determining potential future defects and timing of potential defects such as refracturing needs or wellbore remediation by performing statistical or mathematical modeling based on the data.

17. The method of claim 16, wherein the well site information comprises at least one of:
a well name, a well location, a name of a well operator, a well identifying number, a date, a time of obtaining the test sample, and a source of the test sample.

18. The method of claim 13, further comprising,
sending a request for at least one of a graphical particle size log and a particle size versus percentile estimation from the data resource to an administrative processor.

19. The method of claim 13, further comprising,
sending a request for an input of the at least one properties of the particles from the data resource to an administrative processor.

20. A method of diagnosing a defect in a hydraulic fracturing process comprising:
obtaining a test sample from at least one of the hydraulic fracturing process before, during, or after the hydraulic fracturing process, during the completion and production process during a life of a processing unit;
determining at least one property of proppant particles in the test sample relative to a control sample,
wherein the control sample comprises a proppant sampled during fracture stimulation of a well bore or a standard sample of the proppant specified for a fracture stimulation of the well bore,
wherein the test sample comprises solids which entered the hydraulic fracturing process and
wherein the property is at least one of a number, size, weight, geometry, sphericity, roundness, compressive strength, crushing strength, tensile strength, elastic modulus, yield stress, ductility, grain size, grain angularity, saturation, hardness, resistivity, porosity, grain density, bulk density, permeability, pressure, and temperature of the proppant particles; and
diagnosing the defect in the hydraulic fracturing process.

21. The method of claim 20 comprising,
diagnosing the defect in the hydraulic fracturing process as a failure to place the proppant particles into a fracture when a number of proppant particle properties does not change or decreases from about 1% to about 10% relative to the control sample.

22. The method of claim 20 comprising,
determining an increase of from about 20% or more of proppant particles exhibiting a change in a least one of sphericity, roundness, and size relative to the control sample, and
diagnosing the defect in the hydraulic fracturing process, completion design, or production drawdown plan as displacement of placed proppant.

23. The method of claim 20 comprising,
determining an increase of from about less than 5% of proppant particles and greater than 10% of formation, and provided that the formation was fracture stimulated, the absence of proppant in the test sample, and
diagnosing the defect in the hydraulic fracturing process as a failure to place proppant into a fracture in a wellbore, a well formation, or a well fracture during or after the hydraulic fracturing process.

24. The method of claim 20 comprising,
determining an increase of from about 10% to about 100% of crushed proppant particles relative to the control sample, and
diagnosing the defect in the hydraulic fracturing process as at least one of unsuitable proppant, unsuitable proppant transport fluid, excessive pressure, and effective stress in a wellbore, a formation, or a fracture during or after the hydraulic fracturing process.

25. The method of claim 20 comprising,
determining an erosion or a corrosion of the proppant over time by comparing a change of at least one property of sphericity, roundness, size, and compressive strength, or other recorded, estimated, or predicted property to the control sample and optionally two or more samples obtained during production, or before, during or after the hydraulic fracturing stimulation and
diagnosing the proppant material change as an indicator of a pressure or rock mechanic change in the formation.

26. The method of claim 1 comprising,
diagnosing the defect in the processing unit with at least one of changes in rock mechanics, formation pore pressure, or effective stress when greater than 20% of formation particles relative to a total distribution of the test sample are fine grained or crushed.

27. The method of claim 1 comprising,
determining the erosion or compaction of the formation over time by comparing a change of relative percentages of particles in test samples, and
diagnosing the producing unit and formation rock property variations.

28. The method of claim 1 comprising, diagnosing the defect in the processing unit as a formation producing issue when about 10% or more of Halite (NaCl) as a solid relative to a total distribution of the test sample is detected.

29. The method of claim 1, wherein the at least one property of the particles is determined by examining the test sample by XRF analysis.
